(19) United States
(12) Patent Application Publication
(10) Pub. No.: US 2011/0244307 A1
(43) Pub. Date: Oct. 6, 2011

(54) LITHIUM-ION BATTERY AND METHOD FOR MAKING THE SAME

(75) Inventors: XIANG-MING HE, Beijing (CN); JIAN-JUN LI, Beijing (CN); JIAN GAO, Beijing (CN); WEI-HUA PU, Beijing (CN)

(73) Assignees: TSINGHUA UNIVERSITY, Beijing (CN); HON HAI PRECISION INDUSTRY CO., LTD., Tu-Cheng (TW)

(21) Appl. No.: 12/981,535

(22) Filed: Dec. 30, 2010

(30) Foreign Application Priority Data
Apr. 2, 2010 (CN) 201010138737.1

(51) Int. Cl. H01M 4/24; H01M 10/02; H01M 4/26

(52) U.S. Cl. 429/152; 429/209; 29/623.5; 29/623.1

(57) ABSTRACT

The present disclosure relates to a lithium-ion battery. The lithium-ion battery includes a positive electrode, a negative electrode, a separator, an electrolyte solution, and an external encapsulating shell. The positive electrode and the negative electrode are stacked with each other and sandwich the separator. The electrolyte solution infiltrates between the positive electrode and the negative electrode. The positive electrode, the negative electrode, the separator, and the electrolyte solution are encapsulated into the encapsulating shell. The positive electrode defines at least one first through-hole. The negative electrode defines at least one second through-hole corresponding to the at least one first through-hole.

### CROSS-REFERENCE TO RELATED APPLICATIONS

This application claims all benefits accruing under 35 U.S.C. §119 from China Patent Application No. 201010138737.1, filed on Apr. 2, 2010, in the China Intellectual Property Office, the disclosure of which is incorporated herein by reference. This application is related to commonly-assigned applications entitled, “LITHIUM-ION POWER BATTERY,” filed ______ (Atty. Docket No. US33617); “LITHIUM-ION STORAGE BATTERY,” filed ______ (Atty. Docket No. US33618); and “LITHIUM-ION BATTERY PACK,” filed ______ (Atty. Docket No. US33619).

### BACKGROUND

1. Technical Field

The present disclosure relates to a lithium-ion battery and a method for making the same.

2. Description of Related Art

A common lithium-ion battery can be a winding type or a stacked type, and includes an encapsulating shell, a positive electrode, a negative electrode, a separator, and an electrolyte solution. The positive electrode, negative electrode, separator, and electrolyte solution are accommodated in the encapsulating shell. The separator is disposed between the positive electrode and the negative electrode. The electrolyte solution sufficiently infiltrates the positive electrode, the negative electrode, and the separator. The positive electrode includes a positive current collector and a positive material layer disposed on the positive current collector. The negative electrode includes a negative current collector and a negative material layer disposed on the negative collector.

The stacked type lithium-ion battery can include a plurality of positive electrodes and negative electrodes, and the positive electrodes and the negative electrodes can be alternately stacked to form a multilayered structure. The adjacent positive electrode and the negative electrode are spaced by the separator. The multilayered structure can be compactly pressed together to decrease a thickness of the lithium-ion battery. Consequently, it is difficult to fill the interstices between the positive electrodes and the negative electrodes with the electrolyte solution. The larger the area of the positive electrodes and the negative electrodes, the higher the number of the stacked layers, and the more difficult it is to fill the electrolyte solution. A long period of time is often needed to allow the electrolyte solution to sufficiently infiltrate into the interstices between the positive electrodes and the negative electrodes. For example, a lithium-ion power battery stands for more than ten hours after the electrolyte solution is filled into the shell. Thus, the production efficiency of the lithium-ion power battery is low. In addition, gas produced during charging and discharging of the lithium-ion battery is difficult to expel out of the lithium-ion battery because of the compactly stacked structure of the positive electrodes and negative electrodes, thereby decreasing the recycling properties of the lithium-ion battery.

What is needed, therefore, is to provide a lithium-ion battery that will overcome the above listed limitations.

### BRIEF DESCRIPTION OF THE DRAWINGS

Many aspects of the present disclosure can be better understood with reference to the following drawings. The components in the drawings are not necessarily to scale, the emphasis instead being placed upon clearly illustrating the principles of the present embodiments. Moreover, in the drawings, like reference numerals designate corresponding parts throughout the several views.

FIG. 1 is an external schematic view of an embodiment of a lithium-ion battery.

FIG. 2 is an internal schematic view of the lithium-ion battery of FIG. 1.

FIG. 3 is a cross-sectional view along line of the FIG. 2.

FIG. 4 is an assembly schematic view between the trough-holes of positive electrodes and negative electrodes of the circled portion IV of FIG. 3.

### DETAILED DESCRIPTION

The disclosure is illustrated by way of example and not by way of limitation in the figures of the accompanying drawings in which like references indicate similar elements. It should be noted that references to “another,” “an,” or “one” embodiment in this disclosure are not necessarily to the same embodiment, and such references mean at least one.

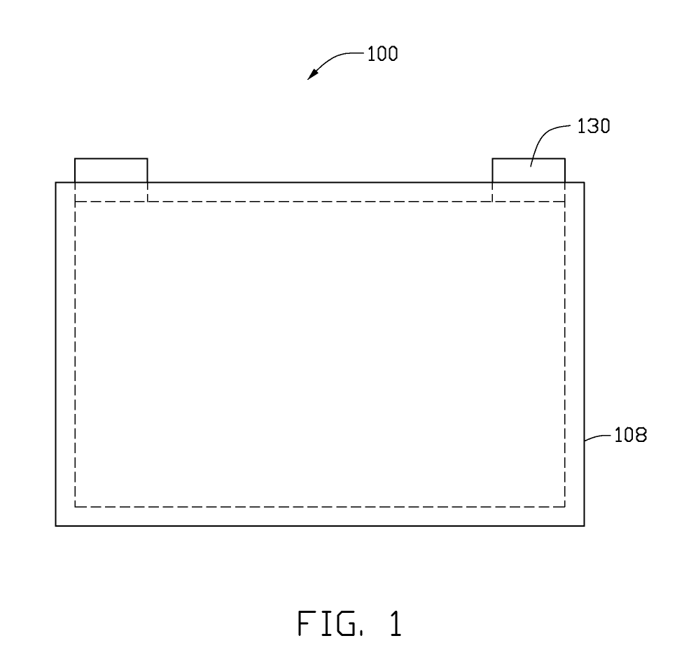

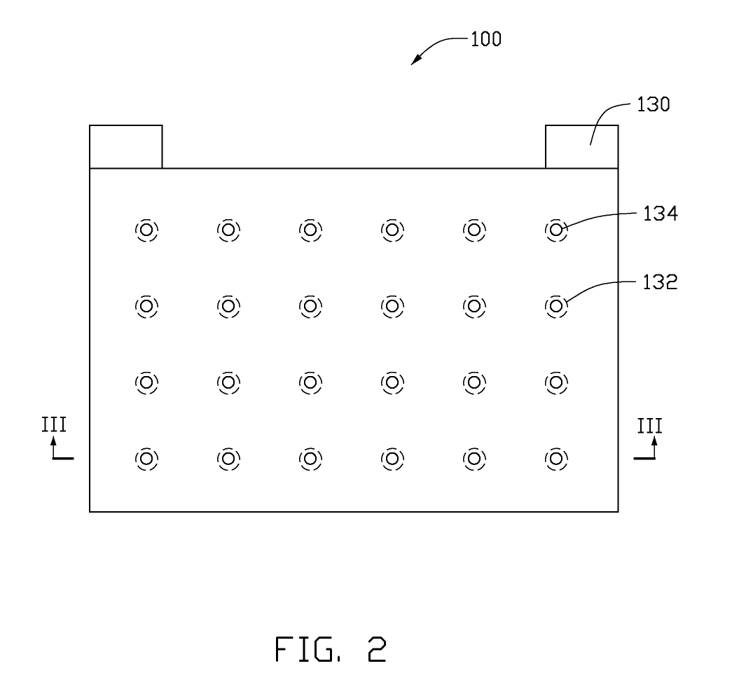

Referring to FIGS. 1, 2, and 3, an embodiment of a lithium-ion battery 100 includes at least one positive electrode 102, at least one negative electrode 104, at least one separator 106, a nonaqueous electrolyte solution, and an external encapsulating shell 108. The positive electrode 102, negative electrode 104, separator 106, and nonaqueous electrolyte solution are encapsulated in the encapsulating shell 108. The positive electrode 102 and the negative electrode 104 are stacked with each other and sandwiches the separator 106. The positive electrode 102 and the negative electrode 104 can be in contact with the separator 106. Furthermore, the lithium-ion battery 100 can include a plurality of positive electrodes 102 and a plurality of negative electrodes 104. The positive electrodes 102 and the negative electrodes 104 are alternately stacked with each other. The adjacent positive electrode 102 and the negative electrode 104 are spaced from each other by the separator 106. The number of the positive electrodes 102 and the negative electrodes 104 are not limited. For example, the lithium-ion battery 100 can include 1 to 100 layers or more of the positive electrodes 102 and the same number of layers of the negative electrodes 104. In one embodiment, the lithium-ion battery 100 includes 20 to 50 layers of the positive electrodes 102 and the same number of layers of the negative electrodes 104.

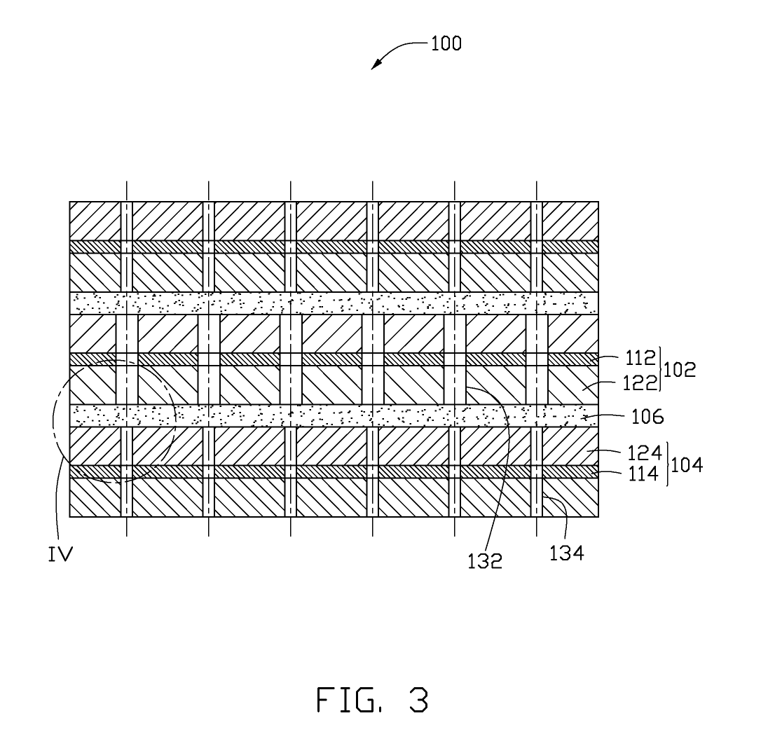

Referring to FIG. 3, each of the positive electrodes 102 includes a positive current collector 112 and at least one positive material layer 122 disposed on at least one surface of the positive current collector 112. Each of the negative electrodes 104 includes a negative current collector 114 and at least one negative material layer 124 disposed on at least one surface of the negative current collector 114. The positive material layer 122 and the negative material layer 124 face each other and sandwiches the separator 106 therebetween. The positive current collector 112 and the negative current collector 114 are sheet shaped. In one embodiment, each of the positive electrodes 102 includes two positive material layers 122 disposed on two opposite surfaces of the positive current collector 112, and each of the negative electrodes 104 includes two negative material layers 124 disposed on two opposite surfaces of the negative current collector 114. If the positive electrodes 102 and the negative electrodes 104 are stacked with each other, the adjacent positive material layer 122 and negative material layer 124 are spaced from each other by the separator 106, and attached to the separator 106.

Furthermore, each of the positive current collector 112 and the negative current collector 114 has a terminal tab 130. The terminal tab 130 of the positive current collector 112 protrudes from the positive material layer 122, and the terminal tab 130 of the negative current collector 114 protrudes from the negative material layer 124. The terminal tab 130 of the positive current collector 112 and the terminal tab 130 of the negative current collector 114 are separated from each other. The terminal tabs 130 are used to electrically connect the positive current collector 112 and the negative current collector 114 with the external circuit. If the lithium-ion battery 100 includes the plurality of positive electrodes 102 and the plurality of negative electrodes 104 alternately stacked with each other, the terminal tabs 130 of the plurality of positive current collectors 112 are overlapped with each other, and the terminal tabs 130 of the plurality of negative current collectors 114 are overlapped with each other.

The positive electrode 102 defines at least one first through-hole 132 through the positive current collector 112 and the positive material layer 122. The negative electrode 104 defines at least one second through-hole 134 through the negative material layer 124 and the negative current collector 114. Each second through-hole 134 is in alignment with one corresponding first through-hole 132. The first and second through-holes 132, 134 have a common axis which can be substantially perpendicular to the separator 106. The electrolyte solution is a liquid. The first through-hole 132 and the second through-hole 134 can be used as a passage for the electrolyte solution. Therefore, the electrolyte solution can infiltrate the interstices between the positive electrode 102 and the negative electrode 104 from the first through-hole 132 or the second through-hole 134, and soak the separator 106. In one embodiment, the positive electrode 102 defines a plurality of first through-holes 132 uniformly distributed, and the negative electrode 104 defines a plurality of second through-holes 134 uniformly distributed. The two opposite surfaces of the positive electrode 102 can be intercommunicated by the first through-holes 132. The two opposite surfaces of the negative electrode 104 can be intercommunicated by the second through-holes 134. The number of the first through-holes 132 and the second through-holes 134 relates to the area of the positive electrode 102 and the negative electrode 104. If a side length of the positive electrode 102 and the negative electrode 104 is less than or equal to 10 centimeters (cm), only one first through-hole 132 can be defined at a center of the positive electrode 102, and only one second through-hole 134 can be defined at a center of the negative electrode 104.

Each of the second through-holes 134 of the negative electrode 104 corresponds to one first through-hole 132 of the positive electrode 102. The number of the first through-holes 132 of the positive electrode 102 can be larger than or equal to the number of the second through-holes 134 of the negative electrode 104. In one embodiment, the number of the first through-holes 132 is equal to the number of the second through-holes 134. In addition, the separator 106 should not define any hole to avoid a short circuit between the positive electrode 102 and the negative electrode 104.

The shape of the first through-holes 132 and the second-holes 134 are not limited, and can be round, square, rhombic, triangular, or any combination thereof. The shape of the first through-holes 132 can be the same as that of the corresponding second-holes 134. For example, if the shape of the first through-holes 132 is round, the shape of the second through-holes 134 corresponding to the first through-holes 134 is also round. The area of each of the first through-holes 132 and the second through-holes 134 can be in a range from about 0.001 square millimeters (mm²) to about 13 mm². The side length or diameter of each of the first through-holes 132 and the second through-holes 134 can be in a range from about 50 micrometers (μm) to about 4 mm. In one embodiment, the first through-holes 132 and the second through-holes 134 are round in shape having a diameter in a range from about 1 mm to about 2 mm. A distance between the axes of the adjacent first through-holes 132 of the same positive electrode 102 is in a range from about 1 cm to about 50 cm. A distance between the axes of the adjacent second through-holes 134 of the same negative electrode 104 is in a range from about 1 cm to about 50 cm. In one embodiment, the distance is about 5 cm. The plurality of first through-holes 132 defined by the same positive electrode 102 can be arranged in rows to form an array, or arranged radially around the center of the positive electrode 102. The plurality of second through-holes 134 defined by the same negative electrode 104 can be arranged in rows to form an array, or arranged radially around the center of the negative electrode 104. An opening ratio of the through-holes is a ratio of the total area of the through-holes in a surface to the total area of the surface. Each of the opening ratio of the first through-hole 132 of the positive electrode 102 and the opening ratio of the second through-hole 134 of the negative electrode 104 can be less than 10%, in one embodiment, less than 2% (e.g. in a range of 1% to 2%). The smaller the opening ratio, the more active material the positive current collector 112 and the negative current collector 114 can carry, thereby avoiding a capacity loss of the lithium-ion battery 100. Further, the small opening ratio can provide enough strength to the positive current collector 112 and the negative current collector 114.

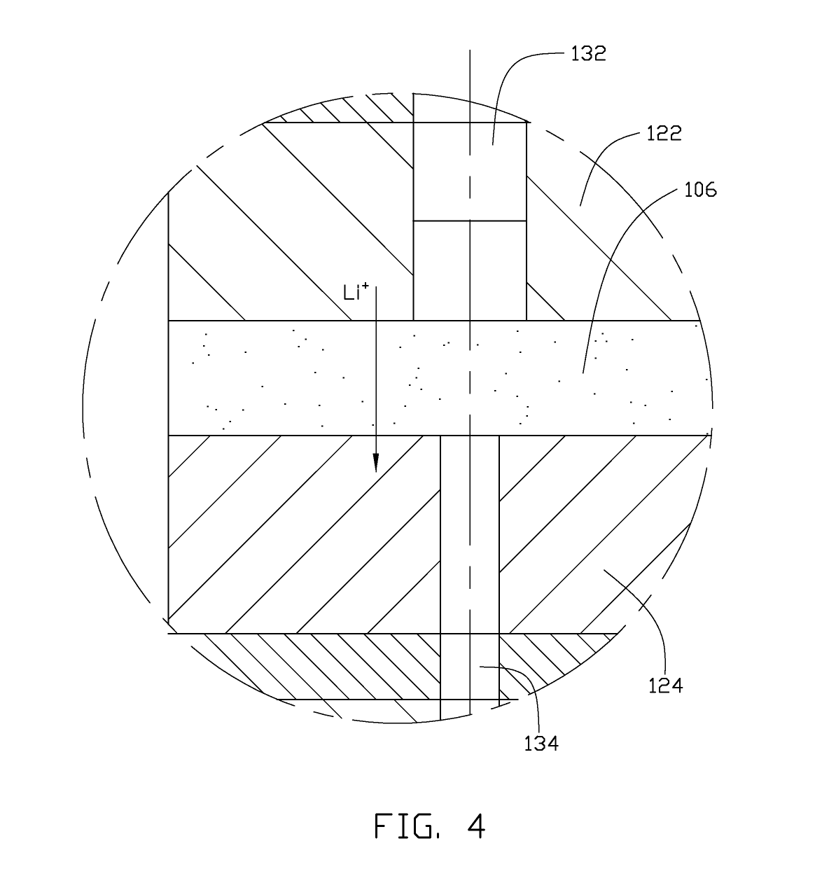

Referring to FIG. 4, a size of the first through-hole 132 of the positive electrode 102 can be larger than or equal to a size of the second through-hole 134 of the negative electrode 104. If the first through-hole 132 and the second through-hole 134 are round in shape, the diameter of the first through-hole 132 can be larger than or equal to the diameter of the second through-hole 134. If the first through-hole 132 and the second through-hole 134 are square in shape, the side length of the first through-hole 132 can be larger than or equal to the side length of the second through-hole 134. In one embodiment, the size of the first through-hole 132 is larger than that of the second through-hole 134 to retain a fitting allowance for assembling the positive electrode 102 and the negative electrode 104 together. If the axis of the first through-hole 132 and the axis of a corresponding second through-hole 134 are not exactly coaxial, the first through-hole 132 can still encompass the second through-hole 134 from a view at a direction substantially perpendicular to the axes of the positive electrode 102 and the negative electrode 104. Namely, a projection of the second through-hole 134 is located in a projection of the first through-hole 132, along a direction substantially perpendicular to the negative electrode 104. Thus, the entire positive material layer 122 of the positive electrode 102 totally falls in the negative material layer 124 of the negative electrode 104 along the direction substantially perpendicular to the negative electrode 104, thereby avoiding a precipitation of the lithium atoms from the positive material layer 122, and improving the safety of the lithium-ion battery 100. The side length or diameter of the first through-holes 132 can be in a range from about one and a half to about twice of the side length or diameter of the second through-holes 134. In one embodiment, the side length or diameter of the first through-holes 132 is about 2 mm, and the side length or diameter of the second through-holes 134 is about 1 mm. If the lithium-ion battery 100 includes a plurality of positive electrodes 102 and a plurality of negative electrodes 104 stacked with each other, the axes of the first through-holes 132 of the plurality of positive electrodes 102 can be aligned with the axes of the corresponding second through-holes 134 of the plurality of negative electrodes 104; or the first through-holes 132 of the plurality of positive electrodes 102 can cover the second through-holes 134 of the plurality of positive electrodes 104 along a direction substantially perpendicular to the positive electrodes 102 and the negative electrodes 104.

The positive current collector 112 and the negative current collector 114 can be made of metal foil. In some embodiments, the positive current collector 112 can be titanium foil or aluminum foil. The negative current collector 114 can be copper foil or nickel foil. A thickness of each of the positive current collector 112 and the negative current collector 114 can be in a range from about 1 μm to about 200 μm. The positive material layer 122 includes a mixture containing positive active material, conductive agent, and adhesive uniformly mixed together. The negative material layer 124 includes a mixture containing negative active material, conductive agent, and adhesive uniformly mixed together. The positive active material can be lithium manganate (LiMn₂O₄), lithium cobalt oxide (LiCoO₂), lithium nickel oxide (LiNiO₂), or lithium iron phosphate (LiFePO₄). The negative active material can be natural graphite, pyrolysis carbon, or mesocarbon microbeads (MCMB). The conductive agent can be acetylene black or carbon fiber. The adhesive can be polyvinylidene fluoride (PVDF) or polytetrafluoroethylene (PTFE). A thickness of the positive electrode 102 can be in a range from about 100 μm to about 300 μm, and a thickness of the negative electrode 104 can be in a range from about 50 μm to about 200 μm. In one embodiment, the thickness of the positive electrode 102 is about 200 μm, and the thickness of the negative electrode 104 is about 100 μm.

The separator 106 can be a polypropylene microporous film. The electrolyte solution includes an electrolyte and an organic solvent. The electrolyte can be lithium hexafluorophosphate (LiPF₆), lithium terafluoroborate (LiBF₄), lithium bis(oxalato)borate (LiBOB), or combinations thereof. The organic solvent can be ethylene carbonate (EC), diethyl carbonate (DEC), dimethyl carbonate (DMC), ethylmethyl carbonate (EMC), propylene carbonate (PC), or combinations thereof. In addition, the electrolyte solution can be substituted with solid electrolyte film or ionic liquid. If the electrolyte solution is substituted with solid electrolyte film, the separator 106 is also substituted with the solid electrolyte film disposed between the positive material layer 122 and the negative material layer 124.

The external encapsulating shell 108 can be a rigid battery shell or a soft encapsulating bag. The terminal tabs 130 are exposed to outside of the external encapsulating shell 108, thereby connecting the external circuit.

A method for making the lithium-ion battery 100 includes the following steps:

S1, providing a positive current collector 112 and a negative current collector 114;

S2, coating a positive material layer 122 on the positive current collector 112 to form a positive electrode 102, and coating a negative material layer 124 on the negative current collector 114 to form a negative electrode 104;

S3, defining at least one first through-hole 132 in the positive electrode 102, and at least one second through-hole 134 in the negative electrode 104, wherein a position of the first through-hole 132 corresponds to a position of the second through-hole 134; and

S4, encapsulating the positive electrode 102 and the negative electrode 104 in the external encapsulating shell 108.

In the step S2, the positive material layer 122 and the negative material layer 124 can be fabricated by the following sub-steps: S21, mixing the positive active material, the conductive agent, and the adhesive solution together, thereby forming a positive slurry, and mixing the negative active material, the conductive agent, and the adhesive solution together, thereby forming a negative slurry; S22, coating the positive slurry on the positive current collector 112 using a coating machine, drying the positive slurry thereby forming the positive material layer 122 on the positive current collector 112, coating the negative slurry on the negative current collector 114 using the coating machine, and drying the negative slurry thereby forming the negative material layer 124 on the negative current collector 114. Furthermore, in step S22, the positive material layer 122 and the negative material layer 124 can be compactly pressed together using a laminator.

In step S3, the first through-hole 132 and the second through-hole 134 can be formed by punching, impact molding, or laser etching. The laser etching can form a small size of the first through-hole 132 and the second through-hole 134. The first through-hole 132 is formed after coating the positive material layer 122 to avoid being blocked by the positive slurry. The second through-hole 134 is formed after the coating of the negative material layer 124 to avoid being blocked by the negative slurry. The first through-hole 132 and the second through-hole 134 can be a one to one correspondence. Specifically, the size of the positive electrode 102 is the same as the size of the negative electrode 104, and the positive electrode 102 and the negative electrode 104 can be located together by a locating device. The first through-hole 132 and the second through-hole 134 are simultaneously formed.

If the lithium-ion battery 100 includes the electrolyte solution or ionic liquid, the above step S4 further includes the following sub-steps of:

S41, providing the separator 106, and disposing the separator 106 between the positive electrode 102 and the negative electrode 104, thereby forming a laminate structure;

S42, pressing the laminate structure using a laminator;

S43, filling the electrolyte solution or the ionic liquid between the positive electrode 102 and the negative electrode 104 from the first through-hole 132 or the second through-hole 134.

In step S41, the separator 106 can be first disposed on a surface of the positive electrode 102, and the negative electrode 104 is then disposed on the separator 106. In the assembling process, the first through-hole 132 of the positive electrode 102 is aligned with the second through-hole 134 of the negative electrode 104. In addition, the lithium-ion battery 100 can include a plurality of the laminate structures overlapping each other.

In step S43, the first through-hole 132 and the second through-hole 134 can form a flowing passage for the electrolyte solution or the ionic liquid. Therefore, the electrolyte solution or the ionic liquid can flow rapidly between the positive electrode 102 and the negative electrode 104, thereby rapidly infiltrating the positive electrode 102, the negative electrode 104, and the separator 106, and improving the production efficiency of the lithium-ion battery 100. The larger the area of the positive electrode 102 and the negative electrode 104, the more obvious the effect of the first through-holes 132 and the second through-holes 134. The area of the positive electrode 102 and the negative electrode 104 can be larger than 400 cm². If the positive electrode 102 and the negative electrode 104 are square, the side length of the positive electrode 102 and the negative electrode 104 can be larger than 20 cm. In one embodiment, the side length of the positive electrode 102 and the negative electrode 104 is in a range from about 50 cm to about 100 cm.

If the solid electrolyte is substituted with electrolyte solution or the ionic liquid, the solid electrolyte can be used as the separator 103 disposed between the positive electrode 102 and the negative electrode 104.

In use, a gas generated by the electrolyte or other element can be easily expelled out of the first through-hole 102 and the second through-hole 104.

Depending on the embodiment, certain steps of the methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. A lithium-ion battery comprising a positive electrode and a negative electrode stacked with each other, wherein the positive electrode defines at least one first through-hole, and the negative electrode defines at least one second through-hole corresponding to the at least one first through-hole.

2. The lithium-ion battery as claimed in claim 1, wherein the at least one first through-hole comprises a plurality of first through-holes, the at least one second through-hole comprises a plurality of second through-holes, and each of the plurality of second through-holes has an axis being in alignment with that of one of the plurality of first through-holes.

3. The lithium-ion battery as claimed in claim 2, wherein a distance between axes of adjacent first through-holes, or a distance between axes of adjacent second through-holes is in a range from about 1 cm to about 50 cm.

4. The lithium-ion battery as claimed in claim 2, wherein each of the plurality of first through-holes is round in shape and has a diameter of 2 mm, each of the plurality of second through-holes is round in shape and has a diameter of 1 mm, and axes of the plurality of first through-holes and the plurality of second through-holes are one to one correspondence.

5. The lithium-ion battery as claimed in claim 4, wherein a distance between the axes of adjacent first through-holes and a distance between the axes of adjacent second through-holes are both about 5 cm.

6. The lithium-ion battery as claimed in claim 1, wherein an axis of the at least one first through-hole is substantially aligned with an axis of the at least one second through-hole.

7. The lithium-ion battery as claimed in claim 1, wherein a shape of the at least one first through-hole is the same as a shape of the at least one second through-hole.

8. The lithium-ion battery as claimed in claim 1, wherein an area of the at least one first through-hole is larger than an area of the at least one second through-hole.

9. The lithium-ion battery as claimed in claim 1, wherein a projection of the at least one second through-hole along a direction perpendicular to the negative electrode is surrounded by a projection of the first through-hole along a direction perpendicular to the negative electrode.

10. The lithium-ion battery as claimed in claim 1, wherein an area of each of the at least one first through-hole and the at least one second through-hole are each in a range from about 0.001 mm² to about 13 mm².

11. The lithium-ion battery as claimed in claim 1, wherein an opening ratio of the positive electrode or the negative electrode is less than 10%.

12. The lithium-ion battery as claimed in claim 1, wherein the positive electrode comprises a positive current collector and at least one positive material layer disposed on at least one surface of the positive current collector, the negative electrode comprises a negative current collector and at least one negative material layer disposed on at least one surface of the negative current collector.

13. The lithium-ion battery as claimed in claim 12, wherein the positive current collector is a titanium foil or aluminum foil.

14. The lithium-ion battery as claimed in claim 13, wherein the negative current collector is a copper foil or nickel foil.

15. The lithium-ion battery as claimed in claim 1, further comprising a separator disposed between the positive electrode and the negative electrode.

16. The lithium-ion battery as claimed in claim 15, further comprising an electrolyte solution or ionic liquid, and an external encapsulating shell, wherein the positive electrode, the negative electrode, the separator, and the electrolyte solution or ionic liquid are encapsulated in the external encapsulating shell.

17. The lithium-ion battery as claimed in claim 1, further comprising a solid electrolyte film disposed between the positive electrode and the negative electrode.

18. The lithium-ion battery as claimed in claim 1, further comprising a plurality of positive electrodes and a plurality of negative electrodes, wherein the plurality of positive electrodes and the plurality of negative electrodes are alternately stacked with and spaced from each other, each of the plurality of positive electrodes defines a plurality of first through-holes, each of the plurality of negative electrodes defines a plurality of second through-holes, and each of the plurality of second through-holes corresponds to one of the plurality of first through-holes.

19. A method for making a lithium-ion battery, comprising:
providing a positive current collector and a negative current collector;
coating a positive material layer on the positive current collector to form a positive electrode, and coating a negative material layer on the negative current collector to form a negative electrode;
defining at least one first through-hole in the positive electrode, and defining at least one second through-hole in the negative electrode; and
encapsulating the positive electrode and the negative electrode in an external encapsulating shell;
wherein an axis of the at least one first through-hole is substantially aligned with an axis of the at least one second through-hole.

20. The method as claimed in claim 19, wherein the step of encapsulating the positive electrode and the negative electrode further comprises the substeps of:
providing a separator disposed between the positive electrode and the negative electrode, thereby forming a laminate structure.
pressing the laminate structure; and
filling an electrolyte solution or an ionic liquid between the positive electrode and the negative electrode from the at least one first through-hole or the at least one second through-hole.
